(19) United States
(12) Patent Application Publication
(10) Pub. No.: US 2020/0070997 A1
(43) Pub. Date: Mar. 5, 2020

(54) AIRCRAFT MOVABLE CONTROL SYSTEM

(71) Applicant: Airbus Operations GmbH, Hamburg (DE)

(72) Inventor: Stefan BENSMANN, Hamburg (DE)

(21) Appl. No.: 16/552,140

(22) Filed: Aug. 27, 2019

(30) Foreign Application Priority Data
Aug. 31, 2018 (GB) 1814240.6

(51) Int. Cl. B64D 45/00; B64C 13/50

(52) U.S. Cl. CPC B64D 45/0005; B64C 13/50

(57) ABSTRACT

An aircraft movable control system comprises a movable component configured to be movably connected to a support component, a time of flight sensor arrangement comprising at least one transponder configured to be attached to the movable component and a corresponding transceiver configured to be attached to the support component wherein the movable sensor arrangement is configured such that one or more range values between the transceiver and the at least one transponder is determinable by the transceiver, and a movable controller configured to process the one or more range values from the transceiver and compute position values of the movable component relative to the support component.

### CROSS-REFERENCES TO RELATED APPLICATIONS

This application claims the benefit of the United Kingdom patent application No. 1814240.6 filed on Aug. 31, 2018, the entire disclosures of which are incorporated herein by way of reference.

### FIELD OF THE INVENTION

The present technology relates to an aircraft movable control system and an aircraft with such a system.

### BACKGROUND OF THE INVENTION

With reference to FIG. 1, an aircraft 001 according to the prior art is shown. The aircraft 001 comprises a plurality of movable components 103, each movably connected to various respective support components 104, namely; a wing 105, a vertical tail 117, a horizontal tail 121 and fuselage 123.

Some of these movable components 103 are movably connected to the wing 105 and tails 117, 121 are commonly referred to as flight control surfaces. Controlled movement of these movable components 103 is effected in precise manner to control the trajectory of the aircraft 001 during flight. The controlled movement of each movable component 103 is commanded by a movable control system computer 113 that receives input position signals via wires from one or more position sensors that are connected to a given movable component 103 (not shown). The input signals are processed according to a predefined logic and output actuation commands are then produced in response that are signaled via wire to one more actuators, which then reposition the movable components 103 as commanded.

Movable components 103 commonly found movably connected to the wing 105 are spoilers 107 on the wing upper surface, flaps 109, ailerons 111 and slats 113. Similarly, the movable components 103 commonly found movably connected to the vertical tail 117 and horizontal tail 121 are the rudder 115 and elevator 119, respectively.

Movable components 103 may also be non-flight control type components connected to the wing 105 or fuselage 123, such as the landing gear 124 (shown retracted), the landing gear doors 125 or the passenger doors 130. The landing gear 124 and landing gear doors 125 are linked and controlled in a similar manner by a further movable control system computer 131 to control the actuation of the gear 124 and/or landing gear doors 125 for takeoff and landing of the aircraft 001.

Other non-flight control type components include access doors 130 such as the passenger and cargo doors, which are linked to a further movable control system computer 131, where in the case of the cargo doors are also operated by a movable control system 131 to control the extension and retraction of the cargo doors. As mentioned, movable component system computers 113, 131 require inputs from one or multiple sensors to satisfactorily indicate to the computer 113, 131 the position of the movable component 103 relative to the support components 104. The movable connection design for each movable component 103 varies. For a given support component and movable component combinations, the movable connection may be simply constrained to one degree of freedom rotation or translation about the relevant support component, or alternatively it may be complex using combination of translation and/or rotation movements about multiple points with more than one degree of freedom. Therefore, different types of sensor types are employed in prior art aircraft 001.

Electromechanical transducer types of sensor are used where position signals are required either over a range of movement or at discrete positions. Position Pick-off Unit (PPU) type sensors that are commonly used in instances where only positional sensing for discrete positions is required between a movable component 103 and a movably connected support component 104.

Other types of sensors such as rotary variable differential transformers (RVDTs), linear variable differential transformers (LVDTs) are used where positional sensing is required over a range of movement between a movable component 103 and a movably connected support component 104.

The extent of positional sensing obtained from the sensor arrangements of the prior art has limitations in terms of physical dimensions, number, and weight and installation complexity of these types of sensors as well as the space in which they must be installed. This limits the utility of these sensors and the range of positional sensing obtainable from a given movable component 103 that movably connected to a support component 104. In some circumstances, combinations of types of sensor are sometimes required to adequately sense the position and load state of the movable component, which increases cost, complexity and maintenance required.

Further limitations exist in some sensor arrangements of the prior art due to maintenance requirements. Such sensors are sensitive to environmental conditions in which they operate and have internal moving parts, for example; input gearing. Degradation of the moving parts may occur depending on the environmental conditions they are subjected to. Furthermore, the sensor bodies are typically designed to directly receive input, contact or induced loading from the movable component or actuator. As a result, many of these types of sensors have limitations in use based on predetermined peak input, contact or induced loads and maximum permissible power density limits the design of the sensor and its applicability. Also, these types of sensors comprise moving internal parts that are inherently capable of becoming mechanically compromised, which normally increases the failure rate and therefore maintenance burden of the use of the system on the aircraft.

In view of the above, an aircraft moveable control system comprising more reliable, less complex sensors is desired, which furthermore is not restricted by the size and dimensions of the sensor itself.

### SUMMARY OF THE INVENTION

An embodiment of the present technology provides an aircraft movable control system comprising

a movable component configured to be movably connected to a support component, a time of flight sensor arrangement comprising at least one transponder configured to be attached to the movable component and a corresponding transceiver configured to be attached to the support component, wherein the movable sensor arrangement is configured such that one or more range values between the transceiver and the at least one transponder is determinable by the transceiver, and a movable controller configured to process the one or more range values from the transceiver and compute position values of the movable component relative to the support component. Use of a time of flight sensor arrangement avoids physical interconnection of a sensor component between a movable component and a movably connected support component resulting in a more reliable sensor arrangement capable of sensing a unlimited range of movement between the movable component and the support component by the controller. Such a control system is also less susceptible to wear from environmental conditions. Lastly integration of a controller in the control system also enables condition detection of the movable connection which enables smarter prediction of maintenance tasks related to the movable connection.

In a further embodiment of the present technology, an aircraft movable control system further comprising an actuator mounted to the movable component and support component, wherein the actuator is configured to actuate the movable component relative to the support component, and wherein the actuator is further connected to the controller and the controller is configured to actuate the movable component in response to a position value determined from the movable sensor arrangement. Integration of an actuator element linked to the controller of the control system enables more accurate failure detection of the actuation system.

In a further embodiment of the present technology, an aircraft movable control system is provided further comprising a second transponder attached to the movable component, wherein the movable sensor arrangement is configured such that a further range value between the transceiver and the second transponder is determinable by the transceiver, and the movable controller is further configured to receive the further range value from the transceiver and compute a further position value of the movable component relative to the support component. Providing a second transponder from which a further range value is obtainable allows for the orientation of the large movable components to be determined without the need to use more complex wired sensor arrangements, which would otherwise add weight and complexity to the overall control system design.

In yet a further embodiment of the present technology, a second transponder is attached to the movable component and the controller is configured to detect a skew condition of the movable component. This removes the need for separate specific sensors to be used to detect this specific failure condition, which further reduces weight and complexity of the overall control system design.

Another embodiment of the present technology comprises an aircraft movable control system wherein the support component also functions as a movable component. Movable components which are not moved for considerable periods of an aircraft operation and which also function to support other movable components that require sensing during extended periods of the aircrafts operation, may be an ideal location for attaching a transponder, for example a spoiler adjacent to a flap or flaperon. This enables new positions for positioning sensor elements that are not possible at present using state of the art sensing systems.

In yet a further embodiment of the present technology, the support component is a wing and the movable component is a flap, spoiler, aileron, flaperon, folding wing tip or slat that is movably connected to the wing. Alternatively, the support component may instead be a fuselage and the movable component may be a flap, spoiler, aileron, or slat that is movably connected to the wing that is fixedly attached at a joint to the fuselage. Such an arrangement is advantageous as it may permit a portion of the sensor arrangement to be placed within a separate component, which enables more design options for the component in terms of available space allocation for other systems or devices.

In yet a further embodiment of the present technology, the support component is a fuselage and the movable component is a door that is movably connected to the fuselage or wing.

In other embodiments of the present technology, the movable connection between the movable component and the support component is constrained to one degree of freedom rotation or translation or alternatively it may comprise a plurality of rotational or translational degrees of freedom.

Lastly, an embodiment of the present technology provides an aircraft comprising an aircraft movable control system.

Advantages of the present technology will now become apparent from the detailed description with appropriate reference to the accompanying drawings.

### BRIEF DESCRIPTION OF THE DRAWINGS

Embodiments of the technology will now be described, by way of example only, with reference to the following drawings in which:

FIG. 1 is an aircraft according to the state of the art.

FIG. 2 is a schematic overview of an aircraft according to exemplary embodiments of the present technology;

FIG. 3 is a schematic overview of an aircraft comprising a plurality of aircraft movable control systems according to exemplary embodiments of the present technology.

### DETAILED DESCRIPTION OF THE PREFERRED EMBODIMENTS

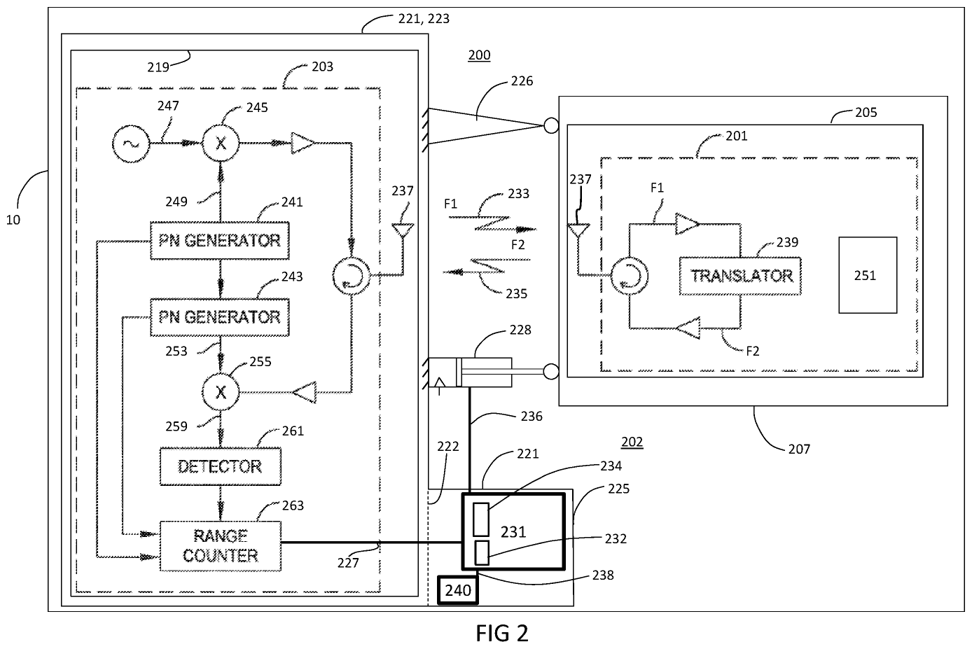

With reference to FIG. 2, an aircraft movable control system 200 according to an embodiment of the present technology is shown. The aircraft movable control system 200 comprises a time-of-flight (TOF) sensor arrangement comprising a transmitting element (in the form of a transponder 201) configured to be attached to a movable component 207, matched to a corresponding receiving element (in the form of a transceiver 203) configured to be attached to a support component 221, and a movable controller 231 that is configured to process one or more output range values from the receiving element in the form of a transceiver 203.

The transceiver 203 is a device comprising both a transmitter and a receiver that share common circuitry. The transmitter is a transmit-only electronic device that produces electromagnetic signals through an antenna 237. The receiver is an electronic receive-only device that receives electromagnetic signals through an antenna 237 and converts the information carried by them to a usable form. The transponder 201 is a device that emits a signal in response to receiving an interrogating signal identifying the transponder 201.

In the present embodiment shown, the transceiver 203 is connected, via an input lead 227, to a movable controller 231. The movable controller 231 comprises a storage medium 232, a processor 234, and an output lead 236 connected to the linear actuator 228, and a command input lead 238 which may connect to a centralized aircraft control computer 240 which is configured to send desired movable position commands to the controller 231 and receive actual movable position data of movable components 207 from the controller 231. The aircraft movable control system 200 uses modulation ranging of pulsed direct sequence spread spectrum (DSSS) signals 233 to determine an output range value at a given instant of the transponder 201 from the transceiver 203.

For a given output range value from the aircraft movable control system 200, a corresponding position value of the movable component 207 is obtainable using the movable controller 231 using the following exemplary process. The output value of the aircraft movable control system 200 is received by the processor 234 of the controller via the input lead 227. The processor 234 is configured to compute an actual position value of the movable component 207 relative to the support component 221 by comparing the output value from the aircraft movable control system 200 against a set of predetermined output values stored on the storage medium 232 that are matched with a corresponding position values.

The processor 234 may compare the position value to a desired value that is obtained from a command input lead 238 that is stored on the storage medium 232. When required, the processor 234 calculates a new position value for the actuator 228 that is commanded via the output lead 236 of the controller 231 to the actuator 228. It should be appreciated that the frequency of the above processes for the movable control system 200 depends on the intervals deemed acceptable for the control and monitoring of the specific deformable component 207 and may depend on the condition of the aircraft 10 at the given instant.

During operation of the aircraft movable control system 200, coded modulation of the transmitted signal 233 and demodulation of a received and re-transmitted signal 235 is done by phase shift modulating a carrier signal. A transmitter portion of the transceiver 203 transmits via an antenna 237 a pseudo-noise code-modulated signal 233 having a frequency F1. The transponder 201 receives the transmitted signal 233 having frequency F1, which is fed to and translated by a translator 239 to a different frequency F2 and is retransmitted by the transponder 201 as the received and re-transmitted signal 235 that is code-modulated having frequency F2. A receiver subsystem (not shown) of the transceiver 203, which is co-located with the transmitter portion of the transceiver 203, receives the re-transmitted signal 235 and synchronizes to the return signal.

By measuring the time delay between the transmitted signal 233 being transmitted and received signal 235, the receiver sub system determines the two-way propagation time delay value to the transponder 201, from which an output range value is determinable. The time delay corresponds to the two-way propagation delay of the transmitted 233 and re-transmitted signals 235.

In FIG. 2, the aircraft movable aircraft movable control system 200 of the present embodiment comprises two, separate, first and second pseudo-noise (PN) code generators 241, 243 for the transmitter and receiver subsystems of the transceiver 203, so that the code at the receiver portion of the transceiver can be out of phase with the transmitted code or so that the codes can be different.

The transmitter portion of the transceiver 203 for measuring TOF distance of an electromagnetic signal comprises the first pseudo noise generator 241 for generating a first phase shift signal, a first mixer 245 which receives a carrier signal 247, which modulates the carrier signal with a first phase shift signal 249 to provide a pseudo-noise code-modulated signal 233 having a center-frequency F1 that is transmitted by the transceiver 203.

The transponder 201 comprises a power source 251 and the translator 239 which receives the pseudo-noise code-modulated signal 233 having center-frequency F1 and translates the pseudo-noise code-modulated signal of frequency F1 to provide a translated pseudo-noise code modulated signal having a center frequency F2 or that provides a different coded signal centered at the center frequency F1, and that is transmitted by the transponder back to the transceiver 203.

The transceiver 203 further comprises the second pseudo noise generator 243 for generating a second phase shift signal 253, and a second mixer 255 which receives the second phase shift signal 253 from the second pseudo-noise generator 243, which receives the translated pseudo-noise code-modulated signal 235 at frequency F2 and modulates the pseudo-correlated code-modulated signal 235 having a center-frequency F2 with the second phase shift signal 253 to provide a return signal 259.

The transceiver 203 further comprises a detector 261 which detects the return signal 259, and a ranging device/counter 263 that measures the time delay between the transmitted signal 233 and the received signal 235 to determine the round trip range from the transceiver 203 to the transponder 201 and back to the transceiver 203.

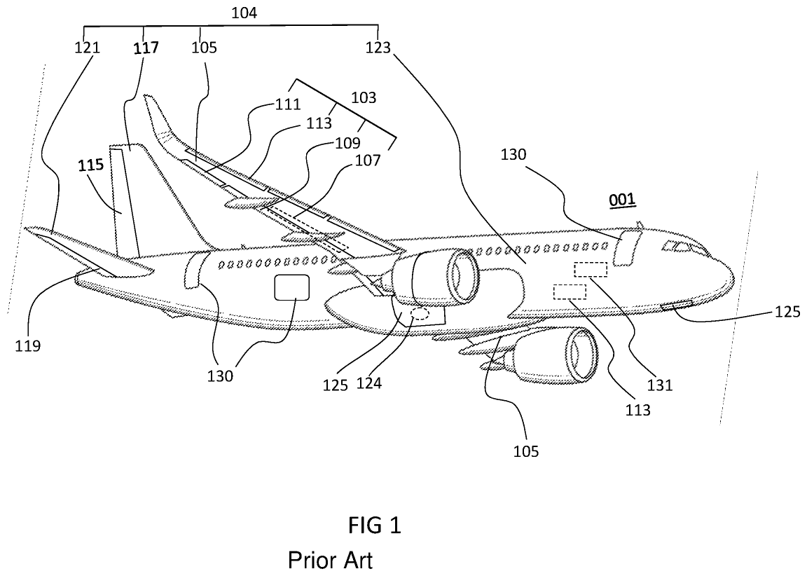

The transponder 201 is configured to be attached to a movable component 207 and further comprises a protective housing 205. The movable component 207 is movably connected to a support component 221, similar to the movable components 103 and support components 104 of the prior art example of FIG. 1. The movable component 207 may, for example, be a spoiler 209, an inboard flap 211, outboard flap 212, aileron 213, inboard slat 215, outboard slat 216, a flaperon (not shown), a folding wingtip 224, a landing gear door 217 or an access door 230.

The transceiver 203 further comprises a protective housing 219 that is configured to be attached to a corresponding support component 221, which may be in the form of a wing 223 functioning as a support component 221 for a movable component 207. Alternatively, the support component 221 may be in the form of a fuselage 225 or wing 223 that supports a movable component 207 such as a landing gear door 217 or an access door 230.

In FIG. 2, a pair of support components 221 that are fixedly attached to one another at a joint 222 are shown, one to which, the transceiver 203 is attached. For example, one support component 221 may be a wing 223, and the second support component to which it is attached may be a fuselage 225.

In the present embodiments, the movable component 207 and the corresponding support component 221 are movably connected by a simple hinge connection constrained to one degree of freedom rotation, which is represented in FIG. 2 by at least one hinge 226 connecting between the components 207, 221. A linear actuator 228 is also mounted to the movable component 207 and support component 221 and configured to actuate the movable component 207 relative to the support component 221. The actuator 228 may be any other suitable type of actuator chosen to actuate the movable component 207. The type of movable connection may also be different. For example, the movable component 207 may be simply constrained to one degree of freedom translation about the support component 221, or have a more complex combination of translational and/or rotational movement about multiple points with more than one degree of freedom.

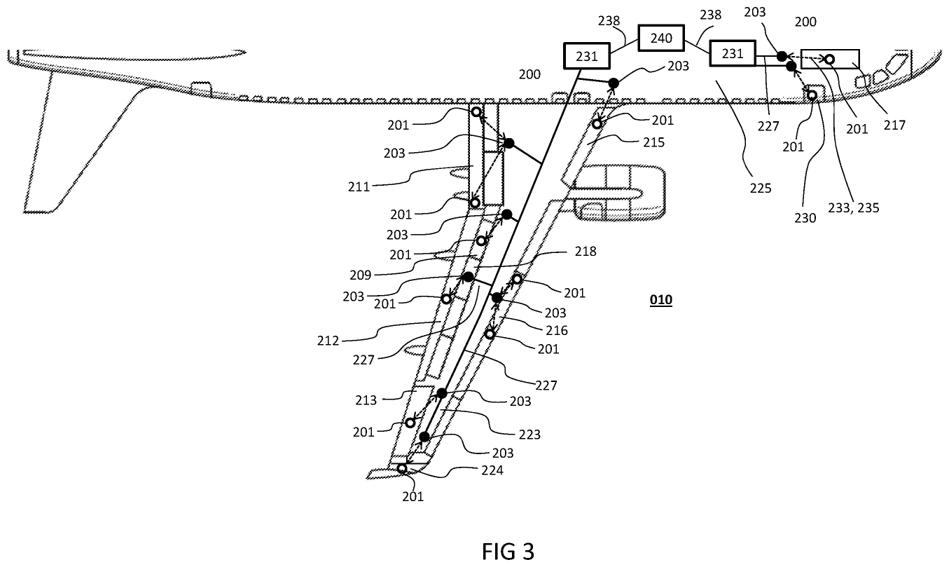

With reference to FIG. 3, embodiments of the present technology comprise an aircraft 10 comprising a pair of separate movable control systems 200 where each movable control system 200 comprising its own movable component controller 231 that is connected to corresponding time of flight sensor arrangements.

In all of the embodiments of FIG. 3 the aircraft movable control system 200 enables output range values of their respective transponders 201 that are fitted to the movable components 207, to be measured and then converted into a corresponding position value of the movable components 207 relative to their corresponding support components 221 using the exemplary process previously described for FIG. 2.

In one embodiment shown, a movable component 207 in the form of a landing gear door 217 is movably connected at the front of the fuselage 225 (the support component 221). The landing gear door 217 is fitted with a transponder 201, which signals with a corresponding transceiver 203 attached to the fuselage 225 that is further connected via an input lead 227 to the movable controller 231 (also referred to as a landing gear controller).

In another embodiment shown, a movable component 207 in the form of a passenger door 230 is movably connected at the front of the fuselage 225 (the support component 221). The door 230 (which is an unactuated door) is fitted with a transponder 201, which signals with a corresponding transceiver 203 attached to the fuselage 225 that is further connected via an input lead 227 to the movable controller 231 (also referred to as a access door controller).

In yet a further embodiment, other movable components 207 on the wing 223, namely the outboard flap 212, spoiler 209, aileron 213, inboard slat 215 and folding wingtip 224 are shown fitted with transponders 201 in a similar fashion to the landing gear door 217 and passenger door 230 previously mentioned. Each transponder 201 signals a corresponding transceiver 203 that are each connected via input leads 227 to a central movable component controller 231 (also referred to as a flight control system controller).

From the arrangement shown for the outboard flap 212, it is should be appreciated that the support component 221 to which the transceiver 203 is attached may itself also function as a movable component 207, as in this case is in the form of a further spoiler 218 which is attached forward of the outboard flap 212.

In a further embodiment of the present technology, other movable components 207 on the wing 223 in the form of an outboard slat 216 and inboard flap 211 are shown each fitted with a pair of transponders 201, each transponder 201 is attached at opposite spanwise ends of each movable component 207 and signals a single corresponding transceiver 203, as shown. This paired aircraft movable control system 200 is advantageous in that for a given instant for the inboard flap 211 and outboard slat 216, the position values obtained by the controller 231 from the output ranges values from both transponders 201 can also be compared against a further set of expected positional values. This not only allows for the orientation of the movable component 207 to be determined, but also if a mismatch between the actual and expected output values occurs, then a slat or flap skew condition can be detected and further movement of the flap 211 or slat 216 can be restricted before any damage occurs.

In all of the embodiments mentioned, the controller 231 may be configured such that the position values obtained by the controller 231 from the output ranges values are compared against desired movable component position commands from the aircraft central controller 240. In this way, the relevant controller 231 can, in a given case, compare the commanded value for a given movable component 207 against the actual position of the movable component 207 to determine whether or not there is a failure of the actuator 228 (in the case that a move command is instructed but no movement of the movable component 207 is detected) and notify the central controller 240 to alert the operator that a failure is possible. Furthermore, the controller 231 may be configured such that a difference between the actual positions achieved by a movable component 207 under a command from the central controller 240 is monitored. When the difference exceeds a predefined threshold, the controller 231 may be further configured to notify the central controller 240 to alert the operator that a maintenance check of the movable component 207 or the support component 221 or actuator 228 is required.

Where in the foregoing description, integers or elements are mentioned which have known, obvious or foreseeable equivalents; then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft movable control system comprising:
a movable component configured to be movably connected to a support component;
a time of flight sensor arrangement comprising at least one transponder configured to be attached to the movable component to form a movable sensor arrangement and a corresponding transceiver configured to be attached to the support component,
wherein the movable sensor arrangement is configured such that one or more range values between the transceiver and the at least one transponder is determinable by the transceiver; and
a movable controller configured to process the one or more range values from the transceiver and compute position values of the movable component relative to the support component.

2. An aircraft movable control system according to claim 1 further comprising:
an actuator mounted to the movable component and support component,
wherein the actuator is configured to actuate the movable component relative to the support component, and
wherein the actuator is further connected to the controller and the controller is configured to actuate the movable component in response to a position value determined from the movable sensor arrangement.

3. An aircraft movable control system according to claim 1, further comprising:
a second transponder attached to the movable component,
wherein the movable sensor arrangement is configured such that a further range value between the transceiver and the second transponder is determinable by the transceiver, and
the movable controller is further configured to receive the further range value from the transceiver and compute a further position value of the movable component relative to the support component.

4. An aircraft movable control system according to claim 3, wherein the position values are compared by the controller to detect a skew condition of the movable component.

5. An aircraft movable control system according to claim 1, wherein the support component also functions as a movable component.

6. An aircraft movable control system according to claim 1, wherein the support component is a wing and the movable component is a flap, spoiler, aileron, flaperon, folding wing tip or slat that is movably connected to the wing.

7. An aircraft movable control system according to claim 1, wherein the support component is a fuselage and the movable component is any one of a flap, spoiler, aileron, or slat that is movably connected to a wing that is fixedly attached at a joint to the fuselage.

8. An aircraft movable control system according to claim 1, wherein the support component is a fuselage and the movable component is a door that is movably connected to the fuselage or wing.

9. An aircraft movable control system according to claim 1, wherein a movable connection between the movable component and the support component is constrained to one degree of freedom rotation or translation.

10. An aircraft movable control system according to claim 1, wherein a movable connection between the movable component and the support component is constrained to a plurality of rotational or translational degrees of freedom.

11. An aircraft comprising an aircraft movable control system according to claim 1.
